(19) United States
(12) Patent Application Publication
(10) Pub. No.: US 2011/0202385 A1
(43) Pub. Date: Aug. 18, 2011

(54) METHOD AND ITS APPARATUS FOR SUPPORTING PROJECT AND PROGRAM FOR CARRYING OUT THE METHOD

(76) Inventors: Takaharu MATSUI, Hayama (JP); Kyoko Ishida, Yokohama (JP)

(21) Appl. No.: 13/023,705

(22) Filed: Feb. 9, 2011

(30) Foreign Application Priority Data
Feb. 15, 2010 (JP) 2010-030022

(51) Int. Cl. G06Q 10/00

(52) U.S. Cl. 705/7.28

(57) ABSTRACT

The present invention provides a project supporting method which presents information on the order of priority of risk information associated with a target project, the method comprising the steps of: determining, on a past projects basis, similarity between risk information about past projects and information indicative of degree of risk for respective risk items that is characteristic to the target project; extracting past projects, the determined similarity of which is higher; creating profit impact-severity information for the respective risk items based on the risk information for the respective risk items and an estimated value and an actual value which are profit parameters for the extracted past projects; creating handling priority-order information from the created profit impact-severity information for the respective risk items regardless of evaluation information about the respective risk items which is inputted by a user; and outputting the created handling priority-order information and the created profit impact-severity information for the respective risk items.

### BACKGROUND

The present invention relates to a technique for, in product designing/development work (project) of software, hardware, and a system composed thereof, supporting decision-making relating to risk items (an unclear matter, an unfixed matter, etc. in the project) which exert influences upon fluctuations in profits (development and manufacturing costs, the sales amount, the amount of profit and loss, etc.) while the project is carried out.

In a start-up or initial stage of a project that involves product development and sales, generally manufacturers check whether or not the project can be achieved and judge a prospect of profits. For the purpose of making such check and judgment, manufacturers evaluate the presence or absence of risk items on the project by use of a checklist, etc. For project activities that should always produce products with originality under the condition that resources and schedules are restricted, many risk items are recognized in the start-up or initial stage of the project. It is not necessarily realistic to handle all of risk items that will not be remarkably problematic, and therefore it is desirable to identify, from many risk items, risk items for which the most effective result is expected, and decide to take corresponding countermeasures for the identified risk items.

Heretofore, a decision-making support technique for handling risk items of a project is disclosed in, for example, JP-A-2001-195483. In such a decision-making support technique, risk impact is calculated on the basis of a probability of occurrence, an impact range, impact severity, and an occurrence frequency, which are optionally inputted by a user on a risk item basis, and thereby the risk handling priority order is presented.

The related art typified by JP-A-2001-195483 has problems that the handling priority order largely depends on input information including a probability of occurrence, an impact range, impact severity, and an occurrence frequency, which are optionally inputted by a user on a risk item basis, and that it is difficult for the user to make a quantitative evaluation about the input information. In addition, the related art further has a problem that risk items are treated as independent events, and thus combined impact of the risk items, which are primarily interdependent on one another, is not taken into consideration.

### SUMMARY

The present invention has been made in view of the abovementioned problems, and an object of the present invention is to provide a technique for presenting the handling priority order in consideration of combined impact of respective risk items of a project without depending on evaluation information about the respective risk items, which is inputted by a user.

In order to achieve the abovementioned object, according to one aspect of the present invention, there is provided a project supporting method which presents information on the order of priority of risk information associated with a target project, the method comprising the steps of: determining, on a past project basis, similarity between risk information for respective risk items that is characteristic to the target project and risk information for respective risk items that is characteristic to each of a plurality of past projects; extracting past projects, the determined similarity of which is higher; creating profit impact-severity information for the respective risk items based on the risk information for the respective risk items and an estimated value and an actual value which are profit parameters, wherein the profit parameters are related to profits of products obtained by each of the extracted past projects having the higher similarity; creating handling priority-order information from the created profit impact-severity information for the respective risk items; and outputting the created handling priority-order information and the created profit impact-severity information for the respective risk items.

In order to achieve the abovementioned object, according to another aspect of the present invention, there is provided a project supporting method which presents information on the order of priority of risk information associated with a target project, the method comprising the steps of: providing first and second information storing means; storing in the first information storing means, on past projects basis, an estimated value and an actual value which are profit parameters related to profits of products of the plurality of past projects and risk information for respective risk items that is characteristic to the past projects; storing in the second information storing means information indicating severity of risk for the respective risk items with respect to the target project; determining, on past projects basis, similarity between the risk information on each of the past projects stored in the first information storing means and information indicating the severity of risk for the respective risk items with respect to the target project and stored in the second information storing means; extracting past projects, the determined similarity of which is higher; creating profit impact-severity information for the respective risk items based on risk information for the respective risk items and an estimated value and an actual value which are the profit parameters for each of the extracted past projects; and outputting the created profit impact-severity information for the respective risk items.

Moreover, in order to achieve the abovementioned object, according to still another aspect of the present invention, there is provided a project supporting apparatus which presents information on the order of priority of risk information associated with a target project, the apparatus comprising: first information storing means for storing in the first information storing means, on past projects basis, an estimated value and an actual value which are profit parameters related to profits of products of the plurality of past projects and risk information for respective risk items that is characteristic to the past projects; second information storing means for storing in the second information storing means information indicating severity of risk for the respective risk items with respect to the target project; project similarity calculation means for determining, on past projects basis, similarity between the risk information on each of the past projects stored in the first information storing means and information indicating the severity of risk for the respective risk items with respect to the target project and stored in the second information storing means; risk-item profit impact-severity information creation means for extracting past projects for which the similarity determined by the project similarity calculation means is higher, and then for creating profit impact-severity information for the respective risk items based on risk information for the respective risk items and an estimated value and an actual value which are profit parameters for each of the extracted past projects; and output means for outputting the risk-item profit impact-severity information.

Furthermore, in order to achieve the abovementioned object, according to a further aspect of the present invention, there is provided a project supporting program used for presenting information on the order of priority of risk information associated with a target project, the program executing: a first storing step for storing in the first information storing means, on past projects basis, an estimated value and an actual value which are profit parameters related to profits of products of the plurality of past projects and risk information for respective risk items that is characteristic to the past projects; a second storing step for storing in the second information storing means information indicating severity of risk for the respective risk items with respect to the target project; a similarity calculation step for determining, on past projects basis, similarity between the risk information on each of the past projects stored in the first information storing means and information indicating the severity of risk for the respective risk items with respect to the target project and stored in the second information storing means; an extraction step for extracting past projects for which the similarity determined in the similarity calculation step is higher; a risk-item profit impact-severity information creation step for creating profit impact-severity information for the respective risk items based on risk information for the respective risk items and an estimated value and an actual value which are profit parameters for each of the extracted past projects extracted in the extraction step; and an output step for outputting the risk-item profit impact-severity information created in the risk-item profit impact-severity information creation step.

The present invention makes it possible to support early and reliable decision to properly handle risks, thereby enabling a reduction in deviation of actual results from a project profit plan, and further enabling contribution to an improvement in operating profits.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram schematically illustrating a configuration of a project supporting apparatus according to one embodiment of the present invention;

FIG. 2 is a diagram illustrating a data configuration of a risk-item contents table according to one embodiment of the present invention;

FIG. 3 is a diagram illustrating a data configuration of a risk-item parameter table of a target project according to one embodiment of the present invention;

FIG. 4 is a diagram illustrating a data configuration of a risk-item parameter table of past projects according to one embodiment of the present invention;

FIG. 5 is a diagram illustrating a data configuration of a profit data table of past projects according to one embodiment of the present invention;

FIG. 6 is a diagram illustrating a data configuration of a project similarity table according to one embodiment of the present invention;

FIG. 7 is a diagram illustrating a data configuration of a risk-item association rule data table according to one embodiment of the present invention;

FIG. 8 is a diagram illustrating a data configuration of a risk-item handling priority parameter table according to one embodiment of the present invention;

FIG. 9 is a flowchart illustrating operation of a project supporting apparatus according to one embodiment of the present invention;

FIG. 10 is a flowchart illustrating, in detail, processing of a step 40 included in a flowchart of FIG. 9;

FIG. 11 is a flowchart illustrating, in detail, processing of a step 50 included in the flowchart of FIG. 9;

FIG. 12 is a front view of an input screen according to one embodiment of the present invention; and

FIG. 13 is a front view of an output screen according to one embodiment of the present invention.

### DESCRIPTION OF THE PREFERRED EMBODIMENTS

One embodiment of a project supporting apparatus according to the present invention will be described with reference to drawings as below.

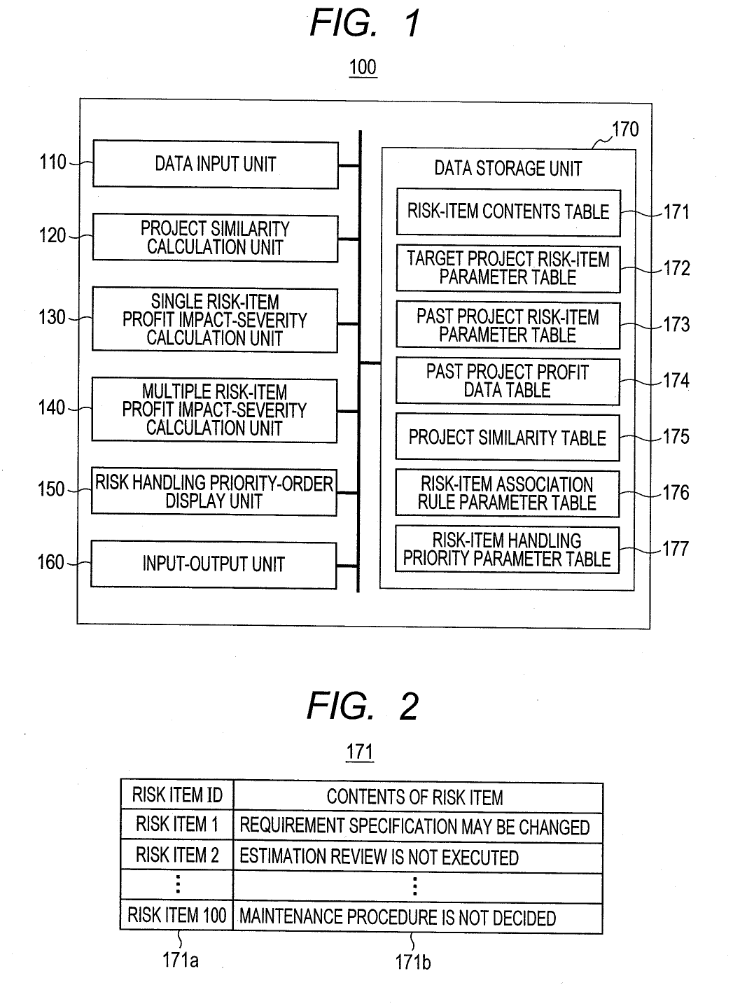

A project supporting apparatus 100 in this embodiment is an apparatus for outputting the priority order in which risk items of a project are to be handled. As shown in FIG. 1, the project supporting apparatus 100 is formed of a computer. The project supporting apparatus 100 includes a data input unit 110, a project similarity calculation unit 120, a single risk-item profit impact-severity calculation unit 130, a multiple risk-item profit impact-severity calculation unit 140, a risk handling priority-order display unit 150, an input-output unit 160, and a data storage unit 170.

The data storage unit 170 stores a risk-item contents table 171, a target project risk-item parameter table 172, a past project risk-item parameter table 173, a past project profit data table 174, a project similarity table 175, a risk-item association rule parameter table 176, and a risk-item handling priority parameter table 177. The risk-item contents table 171 contains contents of a plurality of risk items such as an unclear matter and an unfixed matter in an initial stage of a project, and IDs of the risk items. The target project risk-item parameter table 172 contains risk-item parameters indicating the severity of risk for respective risk items for a project to be supported (hereinafter, a group of risk-item parameters is referred to as a “risk-item parameter group”). The past project risk-item parameter table 173 contains risk-item parameter groups of a plurality of past projects. The past project profit data table 174 contains various kinds of profit data relating to a plurality of past projects. The project similarity table 175 contains similarity between a risk-item parameter group of a target project and each of risk-item parameter groups of a plurality of past projects. The risk-item association rule parameter table 176 contains an association rule between profit data and a plurality risk items. The risk-item handling priority parameter table 177 contains handling priorities for respective risk items.

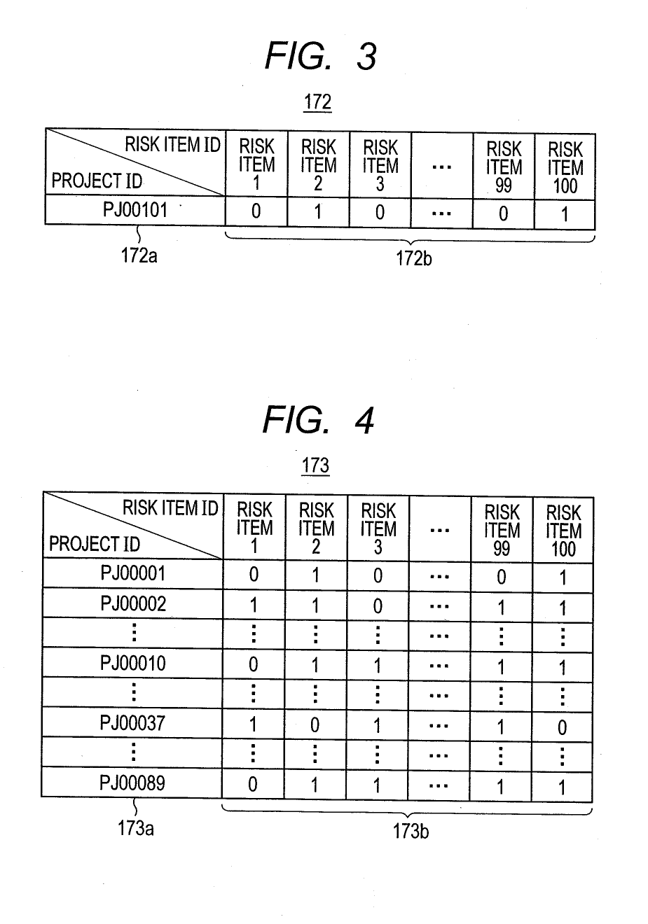

As shown in FIG. 2, the risk-item contents table 171 has: risk item ID areas 171a, each of which stores each risk item ID; and risk-item contents areas 171b, each of which stores contents of a risk item corresponding to each risk item ID. Data is stored beforehand in the risk-item ID areas 171a and the risk-item contents areas 171b of the risk-item contents table 171 before various kinds of data are inputted.

As shown in FIG. 3, the target project risk-item parameter table 172 has: a project ID area 172a which stores a project ID of a target project; and a parameter group area 172b which stores a risk-item parameter group that is a group of risk-item parameters. As a risk-item parameter indicating the severity of risk for each risk item, “0” indicative of having no risk or “1” indicative of having a risk is stored in each field of the parameter group area 172b. Incidentally, only two kinds of values (“0” or “1”) are used as risk-item parameter values here. However, it may be so configured that three or more kinds of values are used.

As shown in FIG. 4, the past project risk-item parameter table 173 has: project ID areas 173a, each of which stores a project ID of each past project; and parameter areas 173b, each of which stores risk-item parameters of each risk-item parameter group.

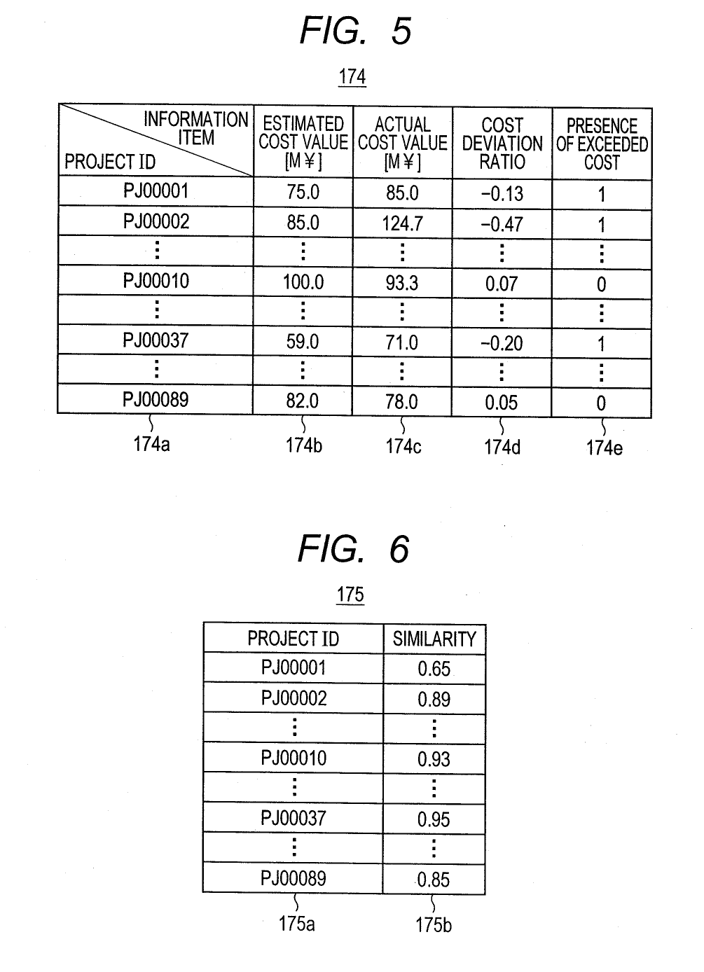

As shown in FIG. 5, the past project profit data table 174 has: project ID areas 174a, each of which stores a project ID of each past project; estimated cost value areas 174b, each of which stores an estimated cost value of each past project; actual cost value areas 174c, each of which stores an actual cost value of each past project; cost deviation ratio areas 174d, each of which stores a cost deviation ratio calculated from an estimated cost value and an actual cost value; and exceeded cost presence areas 174e, each of which stores a value indicating the presence of exceeded cost calculated from an estimated cost value and an actual cost value.

As shown in FIG. 6, the project similarity table 175 has: project ID areas 175a, each of which stores a project ID of each past project; and similarity areas 175b, each of which stores the similarity between a risk-item parameter group of each past project and a risk-item parameter group of a target project.

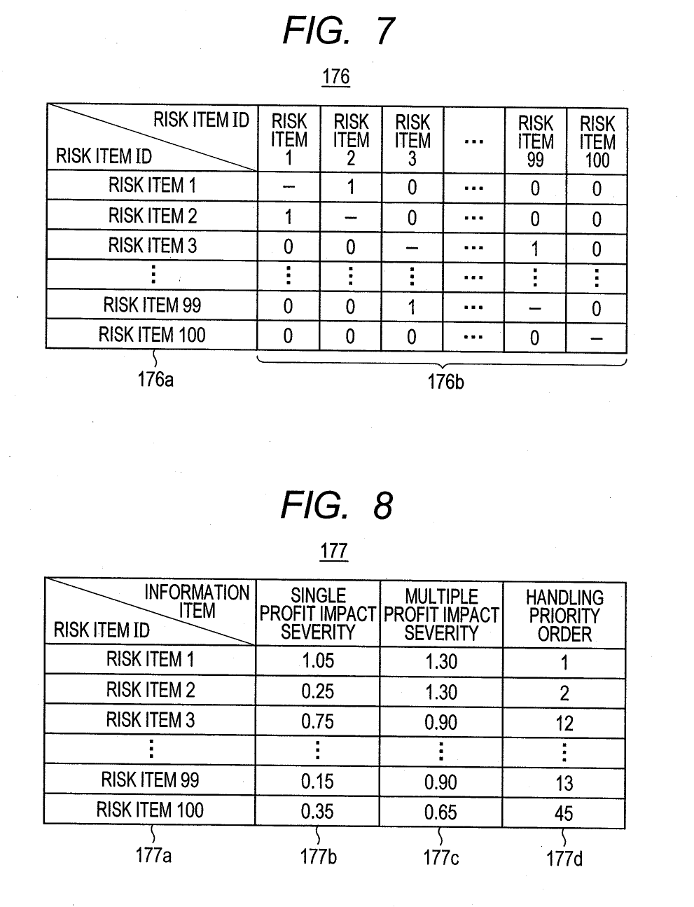

As shown in FIG. 7, the risk-item association rule parameter table 176 has: risk item ID areas 176a, each of which stores each risk item ID; and parameter areas 176b, each of which stores association rule parameters for each risk item.

As shown in FIG. 8, the risk-item handling priority parameter table 177 has: risk item ID areas 177a, each of which stores each risk item ID; single profit impact-severity areas 177b, each of which stores profit impact severity of each single risk item; multiple profit impact-severity areas 177c, each of which stores profit impact severity of multiple risk items; and handling priority order areas 177d, each of which stores the handling priority order of each risk item calculated from the multiple profit impact severity and the single profit impact severity.

Next, the operation of the project supporting apparatus 100 will be described.

In order to output handling priority-order information about a plurality of risk items of a project by the project supporting apparatus 100, it is necessary to input profit data and risk-item parameters of a number of past projects into the project supporting apparatus 100 beforehand.

For this reason, the data input unit 110 of the project supporting apparatus 100 accepts IDs of a plurality of past projects, estimated cost values and actual cost values of the past projects, and risk-item parameter groups of the past projects through the input-output unit 160. The accepted risk-item parameter group of a past project is a group of risk-item parameters that correspond to respective risk items and that are stored in the risk-item contents areas 171b (FIG. 2) respectively. In addition, data is stored by the data input unit 110 in the past project profit data table 174 shown in FIG. 5 in such a manner that IDs of past projects are stored in the project ID areas 174a respectively, estimated cost values of the past projects are stored in the estimated cost value areas 174b respectively, and actual cost values of the past projects are stored in the actual cost value areas 174c respectively. Moreover, data is stored by the data input unit 110 in the past project risk-item parameter table 173 shown in FIG. 4 in such a manner that IDs of past projects are stored in the project ID areas 173a respectively, and risk-item parameter groups of the past project is stored in the parameter areas 173b respectively.

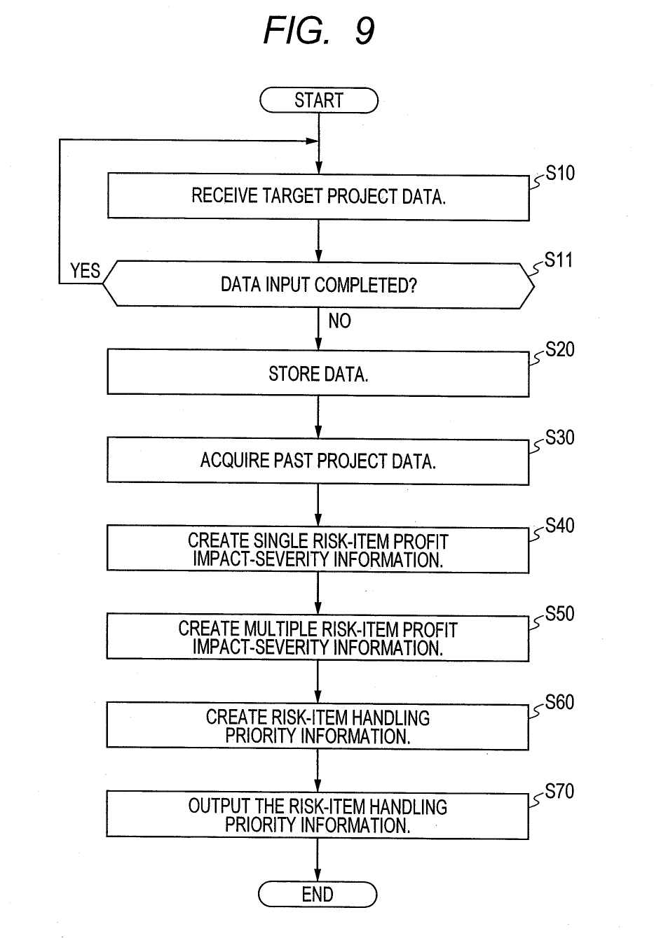

Once the acceptance of the profit data and risk-item parameters of the past projects described above is completed, the project supporting apparatus 100 is ready to accept risk-item parameters, etc. of a target project at any time, and thereby to create handling priority-order information of risk items of the target project. In other words, the project supporting apparatus 100 is ready to execute steps shown in flowcharts of FIGS. 9 to 11.

The operation of the project supporting apparatus 100 will be described according to the flowcharts shown in FIGS. 9 to 11 as below.

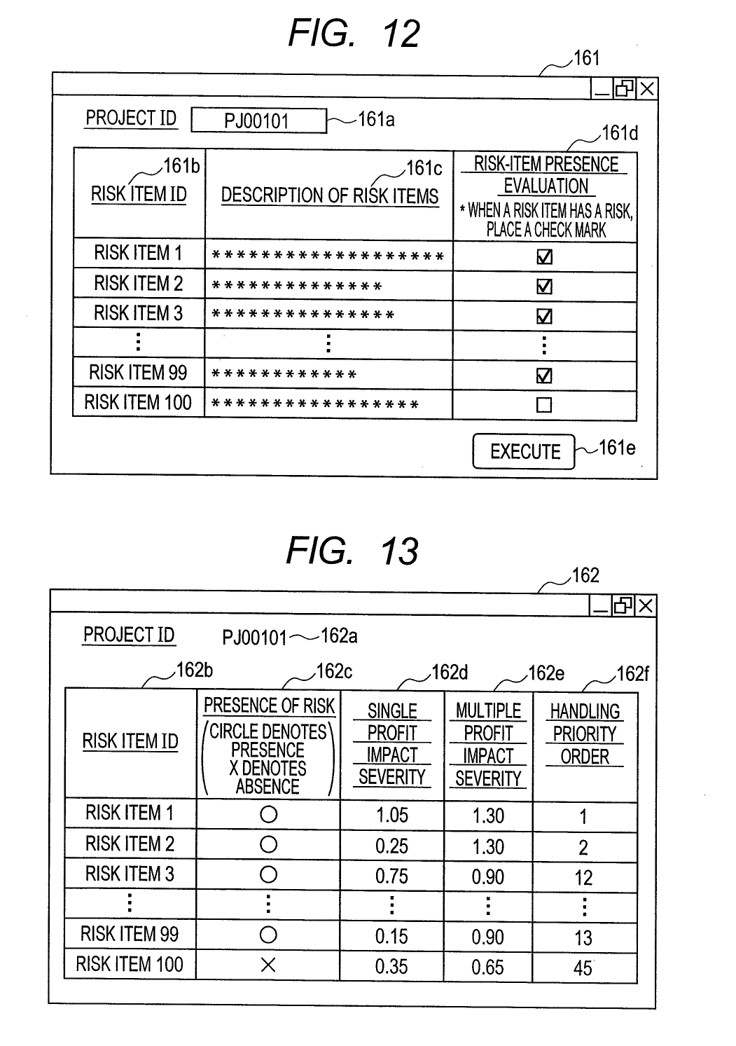

As shown in the flowchart of FIG. 9, the data input unit 110 of the project supporting apparatus 100 accepts various kinds of data about a target project through the input-output unit 160 (S10). In this case, the data input unit 110 instructs the input-output unit 160 to display an input screen 161 shown in FIG. 12. The input screen 161 includes: a project ID input field 161a into which a project ID of a target project is inputted; risk item ID fields 161b, each of which displays each risk item ID stored in the risk-item contents table 171 (FIG. 2); risk-item description fields 161c, each of which displays the description of risk item contents of each risk item ID; and risk-item presence evaluation fields 161d in which presence of a risk item for each risk item ID is displayed as a check mark.

A user of the project supporting apparatus 100 views the input screen 161 to operate the input-output unit 160, and then inputs a project ID “PJ00101” of a target project into the project ID input field 161a. Moreover, referring to risk item contents displayed in the risk-item description fields 161c, if the user knows a risk for a risk item, a check mark is placed in the corresponding risk-item presence evaluation field 161d.

After the user completes inputs to all the fields 161a to 161d, the user presses an [Execute] button 161e of the input screen 161. If the user presses the [Execute] button 161e before the completion of inputting to the fields 161a to 161d, the data input unit 110 determines that data input is not completed (S11), and then prompts the user to input data that is not yet inputted. In case data input has been completed, the data input unit 110 instructs to store input data in corresponding areas (S20).

To be more specific, the data input unit 110 instructs to store the input data in the target project risk-item parameter table 172 shown in FIG. 3 in such a manner that the project ID “PJ00101” of the target project is stored in the project ID area 172a, and a risk-item parameter group “0, 1, 0, . . . , 0, 1” of the target project is stored in risk item ID fields of the parameter group area 172b respectively. In this case, the data input unit 110 gives a value of “1” (having a risk) to a parameter of some risk item ID corresponding to the risk-item presence evaluation field 161d in which a check mark is placed, gives a value of “0” (having no risk) to a parameter of some risk item ID corresponding to the risk-item presence evaluation field 161d in which a check mark is not placed. The given values is then stored in the risk item ID fields of the parameter group area 172b.

Next, the single risk-item profit impact-severity calculation unit 130 reads the risk-item parameter table 172 of the target project, the risk-item parameter table 173 of past projects, and the profit data table 174 of the past projects from the data storage unit 170 (S30); and the single risk-item profit impact-severity calculation unit 130 and the project similarity calculation unit 120 then create profit impact-severity information of a single risk item (S40).

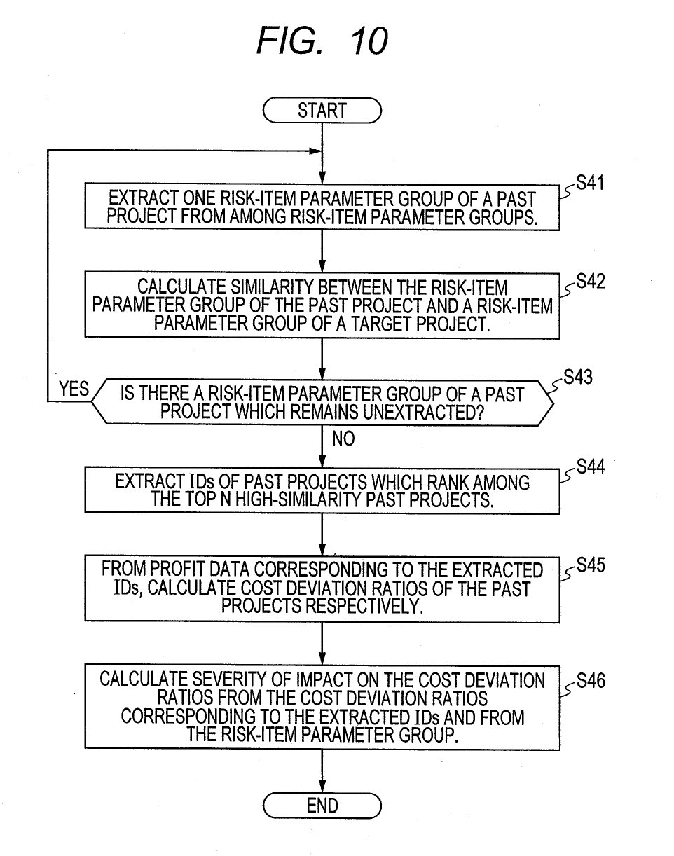

Here, the creation process (S40) of creating the profit impact-severity information of the single risk item by the single risk-item profit impact-severity calculation unit 130 and the project similarity calculation unit 120 will be described according to a flowchart shown in FIG. 10.

The project similarity calculation unit 120 extracts one risk-item parameter group of any project ID (for example, parameters of risk items for a project ID “PJ00001”) from the past project risk-item parameter table 173 (FIG. 4) (S41), and then calculates similarity S between the extracted risk-item parameter group and a risk-item parameter group stored in the target project risk-item parameter table 172 (FIG. 3). Subsequently, the project similarity calculation unit 120 stores the data in the project similarity table 175 (FIG. 6) in such a manner that the past project ID “PJ00001” is stored in the project ID area 175a, and the calculated similarity S is stored in the corresponding similarity area 175b (S42).

The similarity S may be determined by, for example, the following equation (Equation 1) that is the easiest technique among similarity calculation techniques. However, collaborative filtering may be employed, or other techniques such as clustering may be employed.

$$S = 1 - \frac{\sqrt{\sum {( Pa , j - Pp , j )}^{2}}}{n} \qquad ( Equation 1 )$$

where:

Pa,j: j-th risk-item parameter of a target project

Pp,j: j-th risk-item parameter of a past project

n: the number of risk-item parameters that constitute a risk-item parameter group

The similarity S determined by this equation (Equation 1) takes a value that is 0 or more and 1 or less; and a value closer to 1 indicates that the similarity is higher.

Next, the project similarity calculation unit 120 checks if there is a risk-item parameter group of a past project which is still not extracted (S43), and repeats the processing in the steps S41 to S43 described above until risk-item parameter groups of past projects are all extracted.

On the completion of extracting all of the risk-item parameter groups of the past projects, the project similarity calculation unit 120 extracts IDs of past projects which rank is among the top N high-similarity past projects (for example, 4 past projects) from the project similarity table 175 (FIG. 6) (S44). In this case, four IDs of “PJ000037 (similarity is 0.95)”, “PJ000010 (similarity is 0.93)”, “PJ000002 (similarity is 0.89)” and “PJ000089 (similarity is 0.85)” are extracted in an example shown in FIG. 6.

Next, the single risk-item profit impact-severity calculation unit 130 uses the estimated cost values E and actual cost values R corresponding to the IDs of the past projects extracted in the step (S44) to determine a cost deviation ratio Dr of each past project by the following equation (Equation 2) (S45).

Dr=(E−R)/E (Equation 2)

For example, in the case of the past project ID “PJ000010”, the single risk-item profit impact-severity calculation unit 130 refers to the past project profit data table 174 shown in FIG. 5 to obtain an estimated cost value E (=100.0) and an actual cost value R (=93.3) corresponding to the ID “PJ000010”, and then substitutes these values in the equation (Equation 2) to determine a cost deviation ratio Dr (=0.07) of the ID “PJ000010”. The single risk-item profit impact-severity calculation unit 130 stores the determined cost deviation ratio Dr in the cost deviation ratio area 174d of the past project profit data table 174 shown in FIG. 5.

The single risk-item profit impact-severity calculation unit 130 calculates single profit impact severity of respective risk item IDs on the cost deviation ratio Dr. The single risk-item profit impact-severity calculation unit 130 then stores the calculated single profit impact severity in the single profit impact areas 177b of the risk-item handling priority parameter table 177 respectively.

In the case of, for example, a risk item ID “risk item 1”, in order to determine the single profit impact severity, project data is divided into two on the basis of a value (0 or 1) of a risk-item parameter, which indicates “having no risk” or “having a risk” respectively, and then an average value of cost deviation ratios Dr is calculated for each of the divided project data. The abovementioned calculation is executed for all risk items m in like manner, and a risk item, an average value of which has significant difference, is extracted from among the risk items by use of a t-test that is one of statistical methods. Further, multi-regression analysis, in which the extracted risk items are explanatory variables and a cost deviation ratio Dr is an objective variable, is performed, and a regression coefficient of each risk item which is the explanatory variable may be used as impact severity. Other techniques may also be used.

The creation process (S40) of creating the profit impact-severity information of the single risk item executed by the single risk-item profit impact-severity calculation unit 130 and the project similarity calculation unit 120 ends by the above operation.

The operation of the project supporting apparatus 100 will be described according to the flowchart shown in FIG. 9 again.

After the creation process (S40) of creating the profit impact-severity information of the single risk item ends, the multiple risk-item profit impact-severity calculation unit 140 and the project similarity calculation unit 120 create profit impact-severity information of multiple risk items (S50).

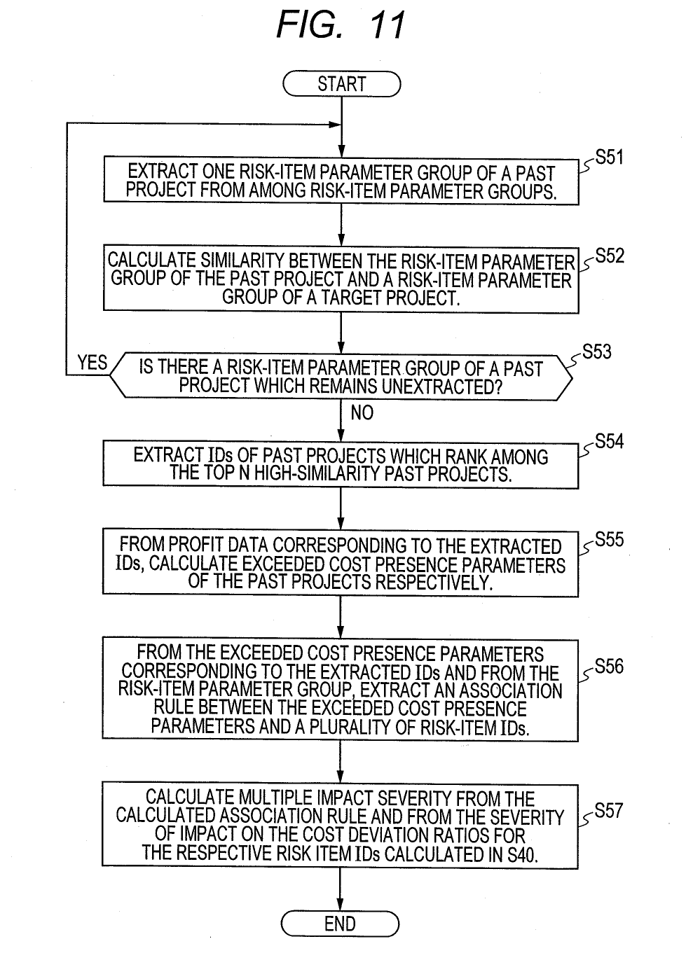

Here, the creation process (S50) of creating the profit impact-severity information of the multiple risk items by the multiple risk-item profit impact-severity calculation unit 140 and the project similarity calculation unit 120 will be described according to a flowchart shown in FIG. 11.

The project similarity calculation unit 120 extracts one risk-item parameter group from the past project risk-item parameter table 173 (FIG. 4) (S51), and then calculates similarity S between the extracted risk-item parameter group and a risk-item parameter group stored in the target project risk-item parameter table 172 (FIG. 3). Subsequently, the project similarity calculation unit 120 stores a past project ID “PJ00001” in the project ID area 175a of the project similarity table 175 (FIG. 6), and also stores the calculated similarity in the project similarity table 175 (S52).

The similarity S may be determined by, for example, the equation 1 that is the easiest technique among similarity calculation techniques. However, collaborative filtering may be employed, or other techniques such as clustering may be employed.

Next, the project similarity calculation unit 120 checks if there is a risk-item parameter group of a past project which is still not extracted (S53), and repeats the processing in the steps S51 to S53 described above until risk-item parameter groups of past projects are all extracted.

On the completion of extracting all of the risk-item parameter groups of the past projects, the project similarity calculation unit 120 extracts IDs of past projects which rank is among the top N high-similarity past projects (for example, 4 past projects) from the project similarity table 175 (FIG. 6) (S54). In this case, four IDs of “PJ000037 (similarity is 0.95)”, “PJ000010 (similarity is 0.93)”, “PJ000002 (similarity is 0.89)” and “PJ000089 (similarity is 0.85)” are extracted in the example shown in FIG. 6.

Next, the multiple risk-item profit impact-severity calculation unit 140 uses the estimated cost values E and actual cost values R corresponding to the IDs of the past projects extracted in the step 54 to determine an exceeded cost presence parameter Z of each past project by the following equation (Equation 3) (S55).

Dr=E−R≧0 [symbol] Z=0,Dr=E−R<0 [symbol] Z=1 (Equation 3)

The multiple risk-item profit impact-severity calculation unit 140 extracts an association rule between an exceeded cost (exceeded cost presence parameter=1) and a risk-item parameter group, and then stores the extracted association rule in the parameter area 176b of the risk item association rule parameter table 176 (FIG. 7) (S56).

The association rule means such a relationship that, for example, if “risk is present for risk item 1” and “risk is present for risk item 2”, “costs are exceeded”, which is expressed as follows: “Risk item 1=1 ∩Risk item 2=1 [symbol] Exceeded cost parameter=1”. This association rule may be determined by performing association rule analysis in which, for example, an exceeded cost presence parameter is an objective variable, and a risk-item parameter group is an explanatory variable, so as to determine support which means the frequency of appearance of rules, and confidence which means a simultaneous occurrence probability, and then by extracting an association rule in which the support and the confidence are specified values or more (for example, support >0.90, confidence >0.70). Other techniques may also be used.

Multiple profit impact severity is calculated from the association rule extracted by the multiple risk-item profit impact-severity calculation unit 140 and from the single profit impact severity stored in the single profit impact area 177b of the risk-item handling priority parameter table 177. Then the calculated multiple profit impact severity is stored in the multiple profit impact-severity area 177c of the risk-item handling priority parameter table 177 (S57).

The multiple profit impact severity may be determined in such a manner that, for example, on the basis of an association rule in which “Risk item 1=1 ∩Risk item 2=1 [symbol] Exceeded cost parameter=1”. In this case, if single profit impact severity of the risk item 1 is 1.05 and single profit impact severity of the risk item 2 is 0.25, multiple profit impact severity is 1.30. Other techniques may also be used.

The creation process (S50) of creating profit impact-severity information of multiple risk items executed by the multiple risk-item profit impact-severity calculation unit 140 and the project similarity calculation unit 120 ends by the above operation.

The operation of the project supporting apparatus 100 will be described according to the flowchart shown in FIG. 9 again.

After the creation process (S50) of creating profit impact-severity information of multiple risk items ends, the multiple risk-item profit impact-severity calculation unit 140 creates handling priority-order information of each risk item ID (S60).

In the step of creating handling priority-order information of each risk item ID, the multiple risk-item profit impact-severity calculation unit 140 uses information stored in the single profit impact-severity area 177b of the risk-item handling priority parameter table 177 and information stored in the multiple profit impact-severity area 177c to calculate a handling priority-order parameter of each risk item ID. The calculated handling priority-order parameter is stored in the handling priority order area 177d.

The handling priority order may be determined in such a manner that, for example, a higher handling priority order is given to a risk item, a multiple profit impact severity value of which is higher, and in the case of the same multiple profit impact severity values, a higher handling priority order is given to a risk item, a single profit impact severity value of which is higher. Other techniques may also be used.

After the creation process (S60) of creating handling priority-order information of each risk item ID ends, the risk handling priority-order display unit 150 instructs the input-output unit 160 to display an output screen 162 shown in FIG. 13 (S70).

The output screen 162 displays a target project ID area 162a, risk item ID areas 162b, risk presence areas 162c, single profit impact-severity areas 162d, multiple profit impact-severity areas 162e, and handling priority order areas 162f.

As described above, in this embodiment, handling priority-order information of a plurality of risk items of a target project is displayed, which makes it possible to assist users in, for example, checking whether or not the target project can be executed, and determining how to handle risks for the purpose of ensuring profits of the target project.

Incidentally, although development and manufacturing costs are used as profit parameters in this embodiment, the present invention is not limited to them. The sales amount of products of a project, the sales quantity of the products, the amount of profit and loss, and the like, may be used as profit parameters. In this case, profit fluctuation information is sales-amount fluctuation information, sales-quantity fluctuation information, and profit-and-loss amount fluctuation information.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

1. A project supporting method, comprising the steps of:
determining, on a past project basis, similarity between risk information for respective risk items that is characteristic to a target project and risk information for respective risk items that is characteristic to each of a plurality of past projects;
extracting past projects, the determined similarity of which is higher;
creating profit impact-severity information for the respective risk items based on the risk information for the respective risk items and an estimated value and an actual value which are profit parameters, wherein the profit parameters are related to profits of products obtained by each of the extracted past projects having the higher similarity;
creating handling priority-order information from the created profit impact-severity information for the respective risk items; and
outputting the created handling priority-order information and the created profit impact-severity information for the respective risk items.

2. The project supporting method according to claim 1, further comprising the steps of:
providing an information storing means; and
storing beforehand, in the information storing means, the risk information for respective risk items that is characteristic to the target project, risk information for respective risk items that is characteristic to each of a plurality of past projects, and an estimated value and an actual value which are profit parameters, wherein the profit parameters are related to profits of products of the plurality of past projects.

3. The project supporting method according to claim 1, wherein the profit impact-severity information for the respective risk item is multiple pieces of risk-item profit impact-severity information for respective risk items.

4. A project supporting method, comprising the steps of:
providing first and second information storing means;
storing in the first information storing means, on past projects basis, an estimated value and an actual value which are profit parameters related to profits of products of the plurality of past projects and risk information for respective risk items that is characteristic to the past projects;
storing in the second information storing means information indicating severity of risk for the respective risk items with respect to the target project;
determining, on past projects basis, similarity between the risk information on each of the past projects stored in the first information storing means and information indicating the severity of risk for the respective risk items with respect to the target project and stored in the second information storing means;
extracting past projects, the determined similarity of which is higher;
creating profit impact-severity information for the respective risk items based on risk information for the respective risk items and an estimated value and an actual value which are the profit parameters for each of the extracted past projects; and
outputting the created profit impact-severity information for the respective risk items.

5. The project supporting method according to claim 4, further comprising the steps of:
creating handling priority-order information based on the created profit impact-severity information for the respective risk items, and then outputting the created handling priority-order information together with the profit impact-severity information for the respective risk items.

6. The project supporting method according to claim 4, wherein the profit impact-severity information for the respective risk item is multiple pieces of risk-item profit impact-severity information for the respective risk items.

7. A project supporting apparatus, comprising:
first information storing means for storing in the first information storing means, on past projects basis, an estimated value and an actual value which are profit parameters related to profits of products of the plurality of past projects and risk information for respective risk items that is characteristic to the past projects;
second information storing means for storing in the second information storing means information indicating severity of risk for the respective risk items with respect to the target project;
project similarity calculation means for determining, on past projects basis, similarity between the risk information on each of the past projects stored in the first information storing means and information indicating the severity of risk for the respective risk items with respect to the target project and stored in the second information storing means;
risk-item profit impact-severity information creation means for extracting past projects for which the similarity determined by the project similarity calculation means is higher, and then for creating profit impact-severity information for the respective risk items based on risk information for the respective risk items and an estimated value and an actual value which are profit parameters for each of the extracted past projects; and
output means for outputting the risk-item profit impact-severity information.

8. The project supporting apparatus according to claim 7, further comprising:
handling priority-order information creation means for creating handling priority-order information based on the risk-item profit impact-severity information for the respective risk items, the risk-item profit impact-severity information being created by the risk-item profit impact-severity information creation means,
wherein the output means outputs the risk-item profit impact-severity information and the handling priority-order information.

9. The project supporting apparatus according to claim 7, wherein
the risk-item profit impact-severity information creation means creates multiple pieces of risk-item profit impact-severity information for the respective risk items.

10. A project supporting program, comprising the steps of:
a first storing step for storing in the first information storing means, on past projects basis, an estimated value and an actual value which are profit parameters related to profits of products of the plurality of past projects and risk information for respective risk items that is characteristic to the past projects;
a second storing step for storing in the second information storing means information indicating severity of risk for the respective risk items with respect to the target project;
a similarity calculation step for determining, on past projects basis, similarity between the risk information on each of the past projects stored in the first information storing means and information indicating the severity of risk for the respective risk items with respect to the target project and stored in the second information storing means;
an extraction step for extracting past projects for which the similarity determined in the similarity calculation step is higher;
a risk-item profit impact-severity information creation step for creating profit impact-severity information for the respective risk items based on risk information for the respective risk items and an estimated value and an actual value which are profit parameters for each of the extracted past projects extracted in the extraction step; and
an output step for outputting the risk-item profit impact-severity information created in the risk-item profit impact-severity information creation step.

11. The project supporting program according to claim 10, the program further executing:
a handling priority-order information creation step for creating handling priority-order information based on the risk-item profit impact-severity information created in the risk-item profit impact-severity information creation step,
wherein the handling priority-order information is output together with the risk-item profit impact-severity information in the output step.

12. The project supporting program according to claim 10, wherein
the creation of the risk-item profit impact-severity information in the risk-item profit impact-severity information creation step is creation of multiple pieces of risk-item profit impact-severity information corresponding to the respective risk items.
